(19) United States
(12) Patent Application Publication
(10) Pub. No.: US 2010/0332287 A1
(43) Pub. Date: Dec. 30, 2010

(54) SYSTEM AND METHOD FOR REAL-TIME PREDICTION OF CUSTOMER SATISFACTION

(75) Inventors: Stephen C. Gates, Redding, CT (US); Youngja Park, Edgewater, NJ (US)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 12/491,095

(22) Filed: Jun. 24, 2009

(51) Int. Cl. G06Q 10/00; G06F 17/27; H04M 3/00

(52) U.S. Cl. 705/10; 704/9; 379/265.09

(57) ABSTRACT

A system and method for real-time prediction of contact center customer satisfaction including means and steps for capturing an interaction between a customer and a customer service agent, converting the captured interaction into transcribed text, analyzing the transcribed text to extract a plurality of unstructured features most closely related to customer satisfaction, combining the extracted features with a plurality of structured features obtained from other contact center data, generating a customer satisfaction score from the combination of extracted unstructured features and structured features, and presenting the customer satisfaction score to contact center personnel.

### FIELD OF THE INVENTION

The invention relates generally to gauging call center customer satisfaction and more particularly to a system and method for real-time prediction of customer satisfaction based on automatic analysis of customer interaction including, but not limited to, telephone calls, on-line chat, and e-mail.

### BACKGROUND OF THE INVENTION

Contact or call centers are critical interfaces between companies and their customers. The top two goals of contact centers are (1) improving productivity while reducing operational costs and (2) retaining customers. The two goals have been perceived as not compatible thereby requiring tradeoffs. Companies have mostly focused on achieving the first goal by automating critical processes or outsourcing customer service to other countries with lower labor cost. This is not only because companies are interested in cost savings but also because they can objectively measure the return on investment (ROI). Most research for contact centers has also been drawn to developing tools for improving agent productivity and saving costs. Examples of such tools range from real-time agent assistance to automatic call monitoring and semi-automated call logging.

Customer satisfaction (C-SAT) is a very important indicator of how successful a company is at providing products and/or services to the customers, and research has shown a strong correlation between customer satisfaction and profitability. However, unlike productivity enhancement and cost saving, it is very hard to objectively measure the ROI on customer satisfaction. One measure could be an increase in sales, but one cannot judge if the sales increase is due to new marketing efforts or to enhanced customer service.

Contact centers typically select a small group of customers for a manual survey after their service requests are closed. A manual customer satisfaction survey is typically conducted via a telephone interview or a mail-in forms, in which customers are asked to evaluate each statement in the questionnaire using multiple-choice or open-ended responses. For example, a typical 5-point Likert-scale question on customer satisfaction might be answered as “Completely Dissatisfied”, “Somewhat Dissatisfied”, “Neutral”, “Somewhat Satisfied”, or “Completely Satisfied”.

Satisfaction is an individual judgment made after experience with a product or service, and, therefore, customer satisfaction has traditionally been measured by interviewing a selected set of customers. C-SAT surveys often measure customer satisfaction level from “1” to “5” a 5-point Likert scale. However, the differences among scores are hard to distinguish even for humans. Especially, the distinctions between 1 (“completely dissatisfied”) and 2 (“somewhat dissatisfied”), and between 4 (“somewhat satisfied”) and 5 (“completely satisfied”) are very vague. The main goal of conducting customer satisfaction survey is identifying satisfied customers and dissatisfied customers to evaluate the performance of their contact center and to improve their service quality. Therefore, in most cases, a binary classification of customers into satisfied customers and dissatisfied customers might be sufficient. Therefore, it is preferable to allow contact centers to measure customer satisfaction into the five C-SAT scores and/or into a binary distinction of customer satisfaction (i.e., “satisfied” vs. “dissatisfied”).

Manual customer satisfaction surveys pose three major limitations. First, they are very expensive since most companies hire an external market research company to conduct surveys. Second, because of the cost, the survey size is typically very small and, thus, the conclusions drawn from the survey are not very reliable. Typically only 1-5% of callers are surveyed, and of these, only a small fraction of callers respond to the survey. Lastly, a manual survey is typically conducted a couple of weeks after a case is finally closed when customer recall may be compromised and when it is often too late to take any action to prevent customer defection of dissatisfied customers.

Automated systems using automated outbound calls and IVR systems have been developed. However, few customers are willing to take the time to answer an automated call, and the response rates for such surveys are very low. A recent study shows that response rates have been falling across all forms of survey research for decades.

It is desirable and an object of the present invention to utilize methods which attempt to infer the customer's satisfaction level from existing data. The major advantage to the data inference approach is that, at least in theory, it is possible to develop estimates of customer satisfaction on effectively 100% of the calls, instead of the 1% or so rates achieved via methods which depend on directly interacting with the customer. Many of the best sources of existing data for such inferencing already exist in most contact centers in e-mails, instance chat messages, call logs and call transcripts.

Previous work has been done on emotion detection in spoken dialogue, sentiment analysis and classification and opinion mining for customer review or feedback documents. However, the prior approaches cannot capture all of the features that affect customer satisfaction. Further, unlike review or feedback text, customer calls will often contain no explicit emotional expressions or may include multiple emotional states. Some customers do not express their sentiments or satisfaction level explicitly during a call. Some customers change their sentiment as the call progresses and the issue gets resolved. Some customers express different sentiments toward different objects in a call. Therefore, emotion or sentiment detection is not sufficient for measuring customer satisfaction.

What is desirable, and is an object of the present invention, is to automatically measure customer satisfaction by analyzing customer interaction texts in real time.

It is an object of the invention to provide a fully automated method for measuring customer satisfaction applying text mining and machine learning technologies on customer interaction texts. This enables companies to measure customer satisfaction at moderate cost in-house, for each and every call, and in real time or at the end of a call, thus overcoming the three major issues with manual customer satisfaction surveys.

### SUMMARY OF THE INVENTION

The present invention provides a system and method for predicting customer satisfaction including means and steps for obtaining a transcript of a customer interaction, for example by capturing a conversation between a customer and a customer service agent and converting the captured conversation into transcribed text if the conversation was carried out by phone; analyzing the interaction transcript to extract a plurality of unstructured features most closely related to customer satisfaction; combining the extracted features with a plurality of structured features obtained from other contact center data; generating a customer satisfaction score from the combination of extracted unstructured features and structured features, and presenting the customer satisfaction score to the customer service agent or other contact center personnel.

### BRIEF DESCRIPTION OF THE DRAWINGS

The invention will hereinafter be described in detail with specific reference to the accompanying figures in which:

FIG. 1 provides a schematic illustration of a system for automatic real-time prediction of customer satisfaction in accordance with the present invention;

FIG. 2 illustrates a representative process flow for automatic real-time prediction of customer satisfaction in accordance with the present invention;

FIG. 3 provides a table listing representative features and approaches for extracting the features;

FIG. 4 provides schematic illustration of a machine learning system for building a customer satisfaction model in accordance with the present invention; and

FIG. 5 provides a process flow for identifying potential structured and unstructured features using customer interaction texts and manual customer satisfaction survey results.

FIG. 6 provides a process flow for identifying potential structured and unstructured features using customer interaction texts labeled with customer satisfaction scores.

### DETAILED DESCRIPTION OF THE INVENTION

The method and system of the current invention automatically create, either during the course of a conversation, or immediately at the end of it, an estimate of the satisfaction of a customer with the service provided by a company's contact center and its agents.

Customer satisfaction is an overall judgment based on cumulative experience with the service and is influenced by multiple factors, including the customer service quality, the time duration spent to have the issue resolved, whether compensation (or other goodwill token, e.g., discount or reimbursement) was offered, to name a few. Therefore, to capture the influence of these multiple factors, various knowledge sources need to be exploited to estimate the level of customer satisfaction. In accordance with the present invention, these knowledge sources include both structured and unstructured features which are highly related to customer satisfaction (C-SAT) scores. The structured features are obtained from information stored in the contact centers' databases. Unstructured data can be derived from many sources, such as customer e-mails, call summaries or “logs” created by the agent at the end of the call, chat sessions, phonetic indexing of the conversations, and so forth. However, the most complete source of information regarding the customer interaction is a full transcript of the conversations between the customer and one or more contact center agents. An automatically-generated transcript is much more cost effective than a manually-generated transcript. Thus, in the preferred embodiment of the present invention, unstructured features are extracted by automatic analysis of automatically-generated call transcripts. Machine learning approaches are then identified which can reliably predict customer satisfaction based on the combined feature set of structured and unstructured features.

It is preferable to apply text mining and machine learning approaches to automatically measure customer satisfaction from customer interaction texts. Several machine learning algorithms have been successfully used for other Natural Language Processing (NLP) tasks, including the following four classification methods: Decision Tree, Naive Bayes, Logistic Regression (a.k.a., maximum entropy classifier), and Support Vector Machine (SVM). As noted above, customer satisfaction cannot be accurately measured based only on a customer's emotional status. Both satisfied customers and dissatisfied customers use more positive sentiment words than negative sentiment words regardless of their satisfaction level. The difference between the number of the positive sentiment words and the number of the negative sentiment words spoken by customers in “satisfied” calls and “dissatisfied” calls is negligible. Accordingly, the inventive method includes identification of which unstructured features are related to customer satisfaction and creation of a customer satisfaction (C-SAT) model for use in generating a predicted C-SAT score.

Customer satisfaction survey forms typically include verbatim comment fields for the customers to provide detailed explanations on why they are satisfied or not satisfied. Verbatim comments can be analyzed to learn what factors impact customer satisfaction with a contact center service and to identify some of the features for future C-SAT prediction. The survey results included the comments that customers provided in interactions which were given a “completely satisfied” rating and a “less than satisfied” rating. Analysis of such survey results for a given type of business can provide features for C-SAT prediction that can then be used to build a suitable C-SAT model for predicting C-SAT with high accuracy, as further detailed below.

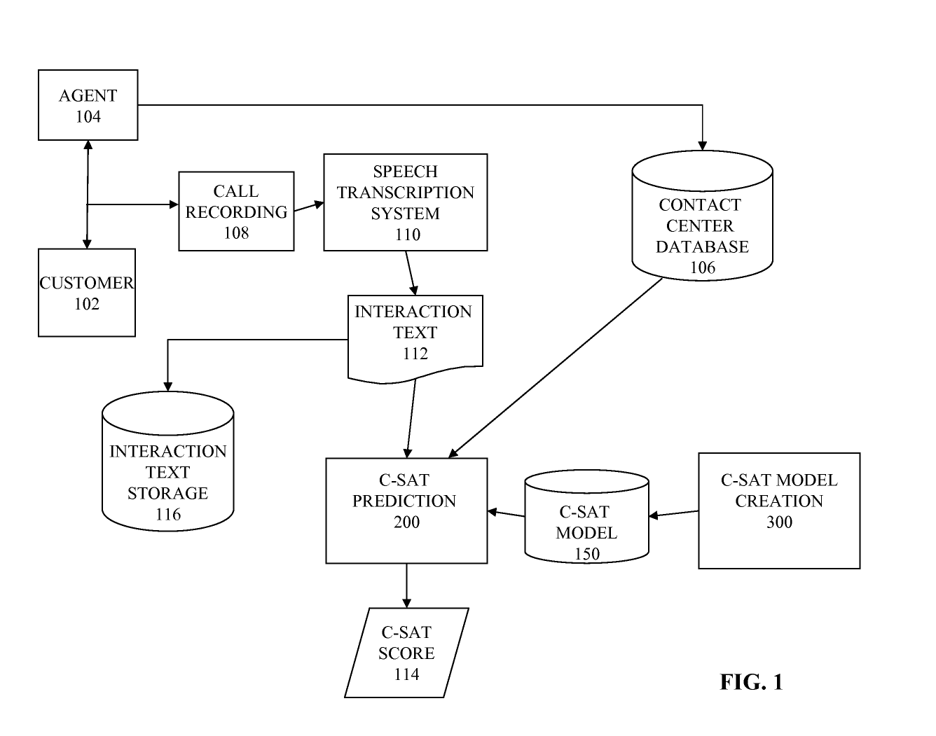

FIG. 1 provides a schematic illustration of a system for automatic real-time prediction of customer satisfaction in accordance with the present invention. The interaction or conversation takes place between a customer 102 and a customer service agent 104. If the conversation is carried out by phone, the conversation is captured at the call recording component 108. The interactions may also be captured in other forms including, but not limited to, computer entries, e-mails, call center logs input by the customer service agent, automatically generated call logs, etc. In the preferred embodiment, the interaction is a telephone conversation between the agent and customer, and a speech transcription system at 110 is provided for receiving the recorded call and performing speech recognition to generate an interaction text 112. The interaction text is provided to the C-SAT Prediction component 200 and also stored in the Interaction Storage component 116.

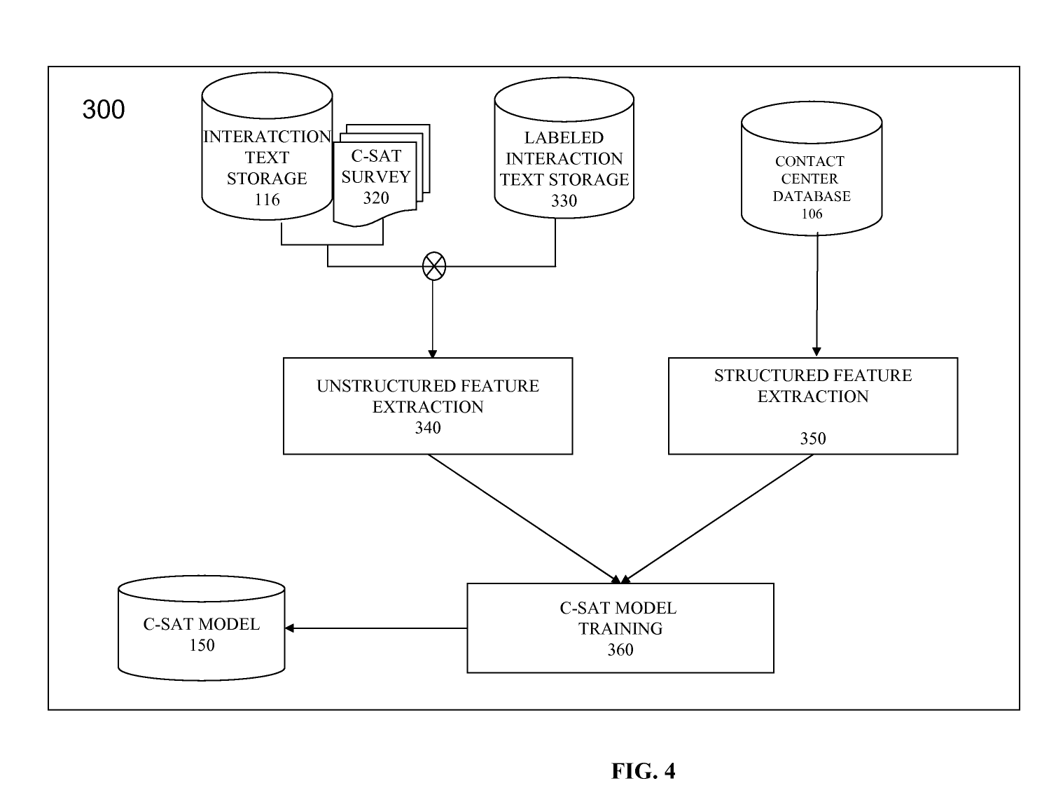

The C-SAT Prediction component comprises at least one processor for executing at least a prediction application and having access to one or more C-SAT models 150, as well as content from one or more contact center databases 106 and the interaction text 112. In the event that there is more than one C-SAT model 150, a C-SAT Model Selector component 118 is used to select which C-SAT model to use. In an example embodiment, the number of prior interactions the customer has initiated before and the type of the goodwill offered by the contact center are obtained from database 106 (as structured features), and prosodic, lexical and contextual features are obtained from the interaction text 112 (as unstructured features). In an example embodiment, the information of call dominance and the number of negative sentiment words spoken by the customer, the information about if a follow-up call was scheduled, etc. are extracted from the call transcript. The prediction component 200 combines the structured and unstructured features on the basis of C-SAT Model 150 to arrive at a customer satisfaction score 114. Details of the C-SAT Model Creation component 300 are described below in FIG. 4. The generated customer satisfaction score may be presented at the customer service agent's computer, displayed at another contact center display, sent via e-mail to one or more parties, or otherwise communicated to the relevant parties.

One important characteristic of the current invention is that the process described in FIG. 1 occurs in real-time; i.e., while the interaction between customer and agent is proceeding. Hence, it is possible and often desirable to generate estimates of the customer satisfaction at various points in the interaction; each of these estimates being based upon the portion of the interaction received so far. This enables actions to be taken based upon these estimates even before the interaction is concluded. Experiments have shown that C-SAT estimates based on partial interactions can in fact be quite accurate.

Once a predicted customer satisfaction score is generated, either during or at the end of the interaction, the contact center can use this in a variety of ways. These ways include, but are not limited to, the following:
generating alerts to contact center supervisors that a customer may be dissatisfied;
causing display to the contact center agent of suggestions for improving satisfaction by the customer to whom the agent is speaking;
providing information to the agent regarding additional options for resolving the customer's issue; and
displaying specific suggestions to the agent for improving the customer's satisfaction level based upon observed features in the interaction.

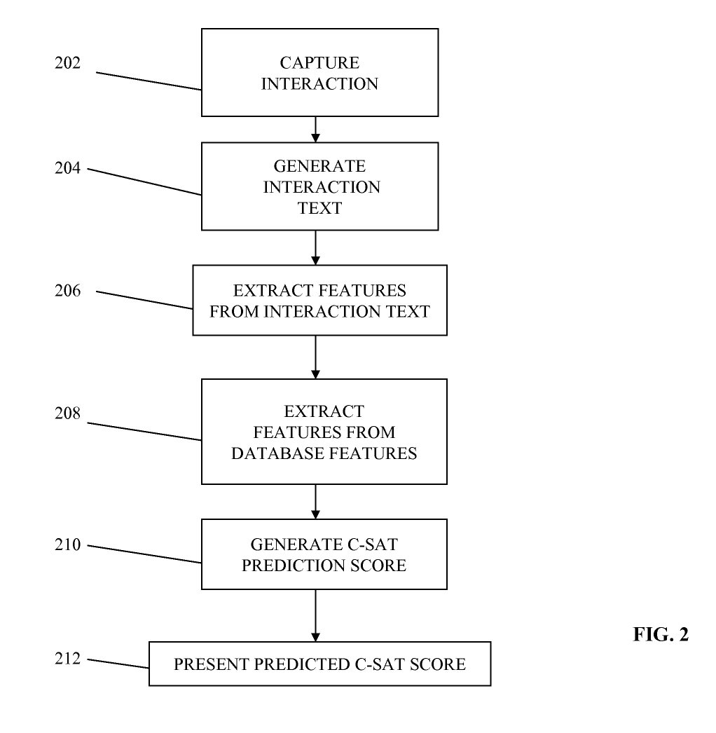

FIG. 2 illustrates a representative process flow for automatic real-time prediction of customer satisfaction in accordance with the present invention. As a first step, shown in FIG. 2 at reference numeral 202, the conversation or interaction between a customer and an agent is captured. As noted above, the interaction may includes entry of content from multiple media, including audio input communicated via telephones or computers and e-mail or chat room content communicated via computers, phones or personal data assistants (PDAs), etc. Once the interaction is captured, an interaction text is generated at step 204. For solely audio input, the captured conversation will be provided to an automatic speech recognition engine for generation of the call transcript. The interaction text is provided to the C-SAT Prediction component for analysis.

Analysis of the interaction text includes a step, at 206, of using Natural Language Processing (NLP) for identifying a plurality of unstructured features in the interaction text that have been previously identified as being related to customer satisfaction. Those unstructured features are combined with structured features which are obtained at 208 from other contact center data stored in one or more contact center databases. At step 210, a customer satisfaction prediction score is generated from the combination of identified unstructured features and structured features on the basis of a previously-created C-SAT Model (described below). The predicted customer satisfaction score is presented at step 212.

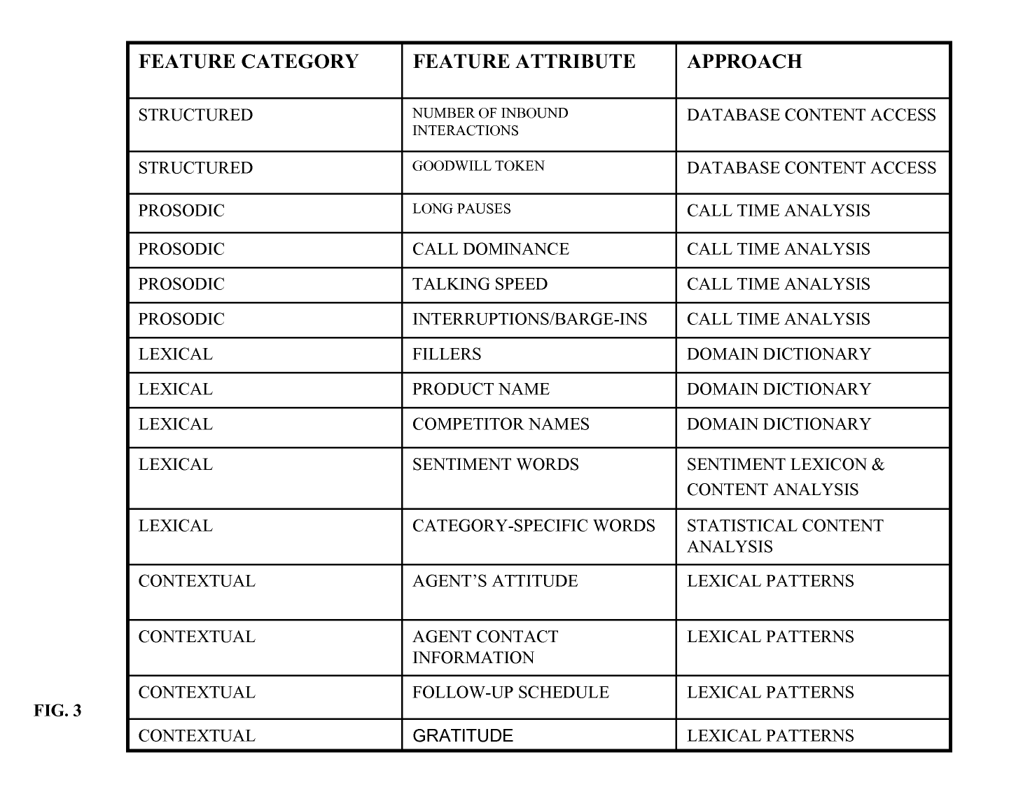

FIG. 3 is a table listing example feature categories from a preferred embodiment, representative features for each category that are useful for C-SAT prediction, and the approach or knowledge sources used for extracting or otherwise identifying those features. It is emphasized that the list of features is not intended to be complete or exhaustive and it should not be used to limit the scope of the invention. The features are categorized into structured, prosodic, lexical and contextual features based on the knowledge sources.

STRUCTURED FEATURES: Often structured features are not available in the call transcripts and must be extracted from the contact center's database(s). The structured features which are often not available in call transcripts include Goodwill and Number of Inbound Interactions.

Goodwill: This feature provides information on whether a goodwill token was offered or not, and the type of goodwill token offered.

Number of inbound interactions: Inbound interactions include any customer-initiated contacts directed to the contact center. Examples of inbound interactions are calls, emails or instant messages which the customer initiated. This feature is the number of previous inbound interactions the customer has made before the telephone conversation.

PROSODIC FEATURES: Prosodic attributes of a conversation provide valuable information about the nature of the call, and have widely been used in speech and dialogue understanding. Previous work extracted prosodic features directly from acoustic signals, and thus utilized more acoustic features such as energy, pitch and frequency. Those acoustic features can imply the emotional state of the speakers. Under the present invention, prosodic features that are available in call transcripts are extracted which can indicate a customer's satisfaction level. The prosodic features include Long Pauses, Call Dominance, Talking Speed, and Barge-ins. It is preferable to include acoustic features such as pitch and energy of the voice from the audio part of the conversation. Prosodic features are generally not available for non-telephony customer interactions. It is emphasized that prosodic features are useful for C-SAT prediction, but the absence of these features does not restrict the scope of the invention.

Long Pauses: Long pauses (e.g., a period between adjacent words lasting more than 5 seconds) during a call can influence the flow of the conversation. For instance, many long pauses by the agent can annoy the customer. The number of all long pauses during a call is used as a feature for classification. In an alternate embodiment, long pauses can be separated into two features: pauses by the agent and pauses by the customer.

Call Dominance: This feature represents who dominated the conversation in terms of the talking time. Study has found that dissatisfied customers tend to dominate the calls more than satisfied customers. The call dominance rate is computed based on the relative talking time between the speakers. The talking time of each speaker (TalkingTime(Sᵢ)) during a call is computed using the following equation.

$$TalkingTime ( {S}_{i} ) = {\sum }_{j = 1}^{n} TimeDuration ( U {ij}_{\underline{\_}} )$$

where Uᵢⱼ denotes the j-th utterance spoken by speaker Sᵢ.

The call dominance rate of a speaker Sᵢ, D(Sᵢ), is computed as the percentage of the speaker's talking time over the talking time of all speakers.

$$D ( {S}_{i} ) = \frac{TalkingTime ( {S}_{i} )}{{\sum }_{k} TalkingTime ( {S}_{k} )}$$

For the present embodiment, the call dominance rate of the customer is used as a feature.

Talking Speed: This feature measures the average talking speed of a speaker. The average talking speed of a speaker is computed by the number of words spoken by the speaker divided by the speaker's talking time in the call. Analysis of calls indicates that agents tend to talk faster in calls that were reported to be “satisfied” calls than in calls reported by “dissatisfied” customers (average speed 1.9 in “satisfied” calls vs. 1.5 in “dissatisfied” calls), while customers tend to speak faster during “dissatisfied” calls (2.5 in “satisfied” calls vs. 2.8 in “dissatisfied” calls). The talking speed of each of the customer and the agent are preferably included in the feature set.

Barge-ins: Interrupting during the other person's speech may indicate that the person is losing patience. When an utterance starts before the previous utterance ends, the utterance is regarded as a “barge-in”. A count is made of the number of barge-ins initiated by each of the agent and the customer.

LEXICAL FEATURES: Previous work on spoken dialogue analysis mostly includes word n-grams as lexical features. For purposes of the present invention, lexical features consist of words which may indicate the customer's emotional state(s) and class-specific words which can reliably distinguish one class from other classes. The lexical features extracted include Fillers, Competitor names, Sentiment works and Category-specific words.

Product Name: This feature specifies the product family name for which the customer is seeking a solution. Typically, customers reveal the product name when they describe the problem they are experiencing, and can be identified by recognizing the product name first mentioned in the customer's utterances. If no product name is found in the customer's utterances, the product name mentioned by the agent can be used. If no product name is found in the customer interaction text, this information can be extracted from the contact center's database.

Fillers: Fillers are words or sounds that people often say unconsciously that add no meaning to the communication. Examples of fillers in English include “ah”, “uh”, “umm”, etc. The frequency of fillers in a conversation is often reflective of a speaker's emotional state. Most contact centers encourage their agents to minimize the use of fillers. As features, the present approach counts the numbers of fillers spoken by the customer and the agent separately.

Competitor names: Mentions of competitors or a competitor's product are good indicators of the customer dissatisfaction with the call center's product. For instance, an unhappy customer might say “I will buy a XXX (a competitor's name) next time”. This sentence does not contain any explicit sentiment, but it certainly has an implicit negative sentiment. For the automotive company example, a manually-compiled lexicon of all automotive companies and their product names is used to automatically recognize competitor mentions. The count of competitors' names mentioned by the customer is used.

Sentiment words: Call center conversations also contain many words showing the speaker's emotion or attitude. To automatically identify words with sentiment polarity, a subjectivity lexicon, stored at a local or remote storage location, is used. A subjectivity lexicon contains a list of words with a priori prior polarity (positive, negative, neutral and both) and the strength of the polarity (strong vs. weak). For purposes of the present invention, it is preferable to use only words for which prior polarity is either positive or negative, and the strength of the polarity is strong. Analysis for sentiment words preferably includes removal of a few words which are frequently used non-subjectively in conversational text, such as “okay”, “kind”, “right”, and “yes”. A local context analysis is also preferably used to decide the polarity of a sentiment word. If a sentiment word has a polarity shifter within a two-word window in the left, the polarity of the word is changed based on the shifter. For example, in “not very happy”, the polarity of “happy” in the context is negative. Once polarity has been determined, the number of positive sentiment words and the number of negative sentiment words spoken by the customer are counted.

Category-specific words: Some words tend to appear more frequently in a certain category than in other categories and thus can reliably identify the category. In a preferred embodiment, a category-specific word database is created by automatically extracting words from prior interactions based upon a measure called Shannon's entropy, which is a measure of the degree of randomness or uncertainty. The entropy of a word, H(w) is computed as follows. A corpus of call transcripts is created, which comprises only the last call (i.e., the conclusory call in a set of one or more related calls) for a plurality of service requests with manual customer satisfaction survey results. Next, the probabilities are calculated for each word, w, appearing in the “satisfied” calls and in the “dissatisfied” calls, and the entropy of each word is computed as defined by the equation below.

$$H ( w ) = - {\sum }_{i = \{ s , d \}} {p}_{i} ( w ) \cdot {log}_{2} {p}_{i} ( w )$$

$$where$$

$${p}_{s} ( w ) = \frac{{f}_{s} ( w )}{f ( w )} , \\ {p}_{d} ( w ) = \frac{{f}_{d} ( w )}{f ( w )}$$

with fₛ(w) and f_{d}(w) denoting the counts of word w in the “satisfied” call set and the dissatisfied set respectively, and f(w)=fₛ(w)+f_{d}(w).

More specifically, category-specific words are defined as words that appear frequently in the corpus and have low entropy. In an example embodiment, words that appear 20 times or more in the corpus and have entropy equal to or less than 0.9 (i.e., words appearing in a category 68% or more of the time) are considered category-specific. Furthermore, if pₛ(w) is bigger than p_{d}(w), the word w is regarded as a “satisfied” word, and otherwise as a “dissatisfied” word. The numbers of “satisfied words” and “dissatisfied words” spoken by the customer are used as features. Once a category-specific word database has been created, it can be used for locating and extracting those words from a current interaction.

CONTEXTUAL FEATURES: Contextual features are phrases or expressions used in certain contexts that can affect the customer's satisfaction level. Four contextual features are preferably extracted using a finite state machine, including agent's positive attitude, agent's contact information, Follow-up schedule and Gratitude.

Agent's positive attitude: Positive attitude features intend to estimate the agent's positive attitude toward the customer. A list of phrases is manually collected, including phrases which agents often use to express courteousness or to rephrase the customer's problem. For example, “let me see if I understood . . . ” and “as I understand . . . ” can hint that the agent is trying to understand the customer's question correctly. Also, expressions like “I am happy to assist/resolve/address . . . ” and “I am sorry to hear . . . ” in the beginning of a call can indicate that the agent was sympathetic and willing to help the customer. In an example embodiment, the number of such expressions in the first ten utterances spoken by the agent is most representative of the agent's positive attitude. Accordingly, a count of such expressions in the first ten utterances is tracked.

Agent's Contact Information: As noted above, customers regard an agent as being more responsive when the agent provides contact information so that the customer can reach them directly. The present embodiment recognizes expressions for a telephone number or an extension number in the last ten utterances spoken by the agent.

Follow-up Schedule: A follow-up is a call made by the agent to the customer after the current call is ended. It cannot be directly known from the transcript of the current call if there was a follow-up. Instead, the system and method check to determine if the agent scheduled a follow-up during the conversation. A follow-up schedule can be an attribute for a responsible agent, but also can indicate that the customer's problem was not resolved during the call. Agents dealing with complex cases usually schedule a follow-up at the end of the call, and obtain the customer's contact information. In an example embodiment, the existence of a follow-up schedule is recognized by identifying expressions for a telephone number, day identification and hour information in the last twenty utterances spoken by the customer.

Gratitude: Finally, the customer's responses at the end of the call are analyzed to recognize expressions showing gratitude. A customer's use of expressions showing gratitude, such as “appreciate” and “great”, indicates that the customer is satisfied. In a sample embodiment the number of such expressions spoken by a customer in the last ten utterances of the conversation is counted.

FIG. 4 illustrates the details of the C-SAT Model Creation component 300 in FIG. 1 for building the customer satisfaction (C-SAT) model in accordance with the present invention. It is desirable to identify feature combinations that are highly related to customer satisfaction scores and that can also be automatically extracted from data sources available at most contact centers. In addition, it is desirable to build models which can measure the degree(s) of customer satisfaction with reasonably high accuracy. Hence, component 300 is designed to use a machine learning approach, as follows.

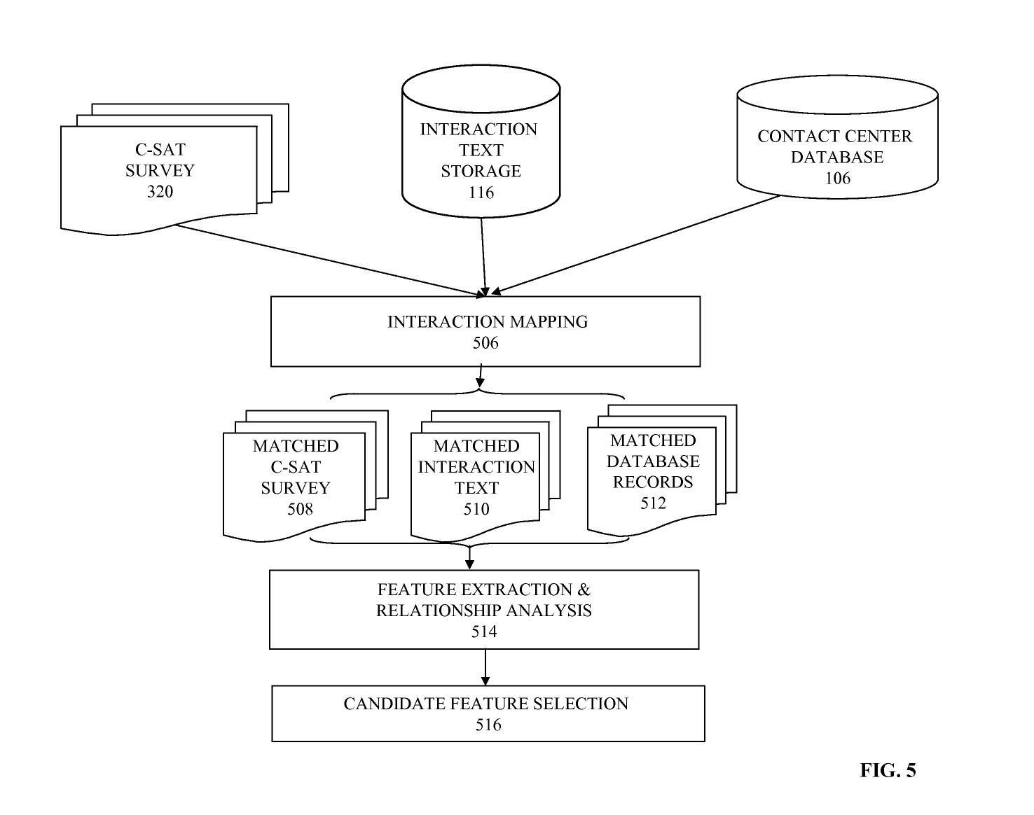

In a preferred embodiment, a C-SAT model can be created using at least one of the two sources described below. The first source is a collection of previous customer interaction texts stored in Interaction Text Storage 116 together with the C-SAT Surveys 320 collected for those stored customer interactions. Separate storage locations are shown, but the content could clearly be stored locally or remotely, in one or more database. An Interaction Mapping component described below in FIG. 5 can be used to associate the calls in the Interaction Text Storage 116 with the corresponding C-SAT surveys. Alternatively, a second source comprising Labeled Interaction Text 330 can be used for creating the C-SAT model. A Labeled Calls or Labeled Interaction Text component (not shown) contains a collection of calls which have already been labeled with the C-SAT scores.

The Unstructured Feature Extraction component 340 extracts unstructured features including prosodic, lexical and contextual features from the stored calls, and C-SAT scores from the C-SAT surveys. Structured features such as goodwill tokens and numbers of inbound interactions are extracted from the contact center database 106 by the Structured Feature Extraction component 350. Finally, a C-SAT model 150 is constructed based on the structured and unstructured features by a C-SAT Model Training component 360 having at least one processor. A C-SAT model can be created by applying existing machine learning approaches including, but not limited to, Decision Tree, Naive Bayes, Logistic Regression and Support Vector Machine (SVM). In one embodiment the various machine learning approaches are compared to select the best performing approach. In another embodiment, multiple approaches are run, and a majority vote among the approaches is used to create a final model.

The C-SAT Model Creation component 300 may be run more than once; for example, it may be run whenever sufficient additional transcripts having C-SAT scores are collected, or in response to input from an agent that the model needs improvement.

FIG. 5 provides a process flow for identifying structured and unstructured features using customer interaction texts and manual customer satisfaction survey results, which features are used to build a C-SAT model in accordance with the system described in FIG. 4. Customer interactions which were the subject of manual C-SAT surveys are identified at Interaction Mapping step 506. The Interaction Mapping component associates, at step 506, customer interaction text with manual C-SAT surveys 320 and database entries stored in the contact center database 106. The interaction mapping is best done by utilizing a unique identifier assigned to each service request and the start and end times of each interaction; however, in some embodiments, the mapping may require matching based on customer IDs or other data.

It is to be noted that a C-SAT survey is generally conducted for a service request and not for an individual interaction. A service request typically consists of multiple interactions between a customer and one or more agents via multi-modal media including telephone conversations, e-mails and postal mail. In many cases, a service request comprises more than one telephone conversations resulting in a 1-to-n relationship between a C-SAT score and customer calls. For ease of associating data consistently, it is preferable to select and analyze service requests which involved only one incoming call from the respective customers for a telephony customer interaction.

The output of step 506 is thus a set containing triples each consisting of a matched C-SAT survey 508, matched interaction text 510, and a matched database record for the interaction 512. Each triple represents 3 types of data for a single customer interaction with the contact center.

Next, the Feature Extraction & Relationship Analysis step 514 identifies those features most related to customer satisfaction. First, a wide range of features is extracted from the data. In the preferred embodiment, the extracted features are those listed in FIG. 3, and the relationship is one of correlation, but in other embodiments the features and relationships may be significantly different depending upon the industry supported by the contact center and the measures of customer satisfaction covered in the C-SAT surveys. The features from the unstructured data can be extracted by a variety of approaches, such as those listed in FIG. 3.

For each candidate feature, the relationship (e.g., correlation) with the C-SAT score is computed at step 514, and structured and unstructured features that are highly related to C-SAT score are selected as candidate features at 516.

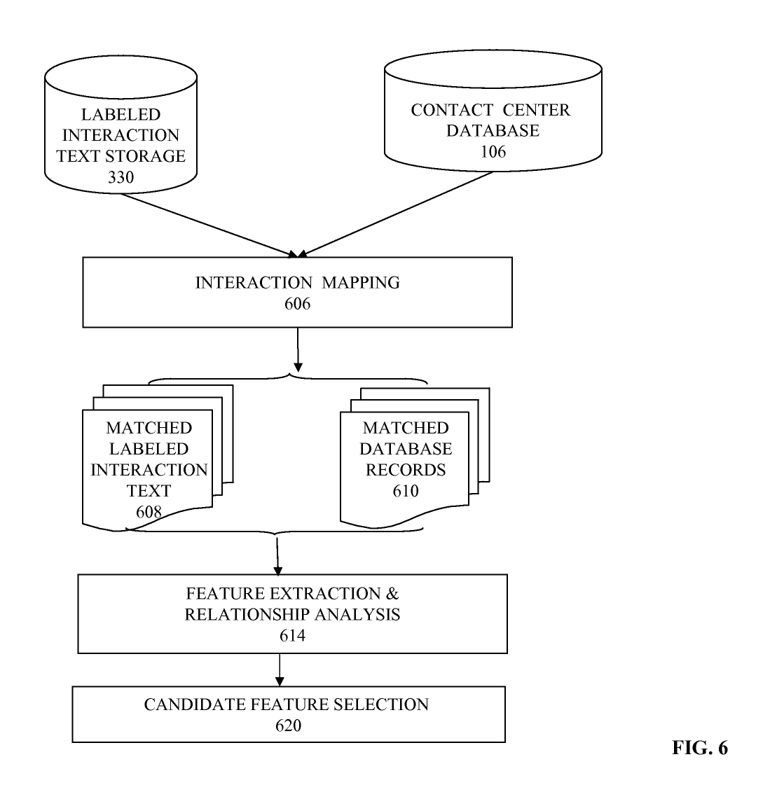

FIG. 6 provides a process flow for identifying structured and unstructured features using customer interaction texts labeled with C-SAT scores. It is analogous to the steps in FIG. 5. Since a C-SAT score is provided for each customer interaction as a label, the Interaction Mapping component associates interaction texts only with the data base records at step 606. In step 606, a call text is mapped to corresponding information in the Contact Center Database 106, using the methods described for step 506 in FIG. 5. The matched data base records 610 and the labeled interaction texts 330 are used to identify features that are highly related to the labeled C-SAT scores at Feature Extraction & Relationship Analysis step 614. Finally, the features that are highly related to the labeled C-SAT are selected as candidate features at 620.

It is noted that the labeling can be done manually by the subject matter experts or semi-automatically. Labeled interactions may include first calls, intermediate calls, last calls with the customer relating to a particular issue, or several segments of an interaction such as occur when a call is transferred from one agent to another.

The methodologies of embodiments of the invention may be particularly well-suited for use in an electronic device or alternative system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer readable medium(s) having computer readable program code embodied thereon.

Any combination of one or more computer usable or computer readable medium(s) may be utilized. The computer-usable or computer-readable medium may be a computer readable signal medium or a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

A computer readable signal medium may include a propagated data signal with computer readable program code embodied therein, for example, in baseband or as a part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

1. A method for real-time prediction of customer satisfaction for a contact center interaction between a customer and at least one customer service agent at the contact center comprising steps of:
obtaining an interaction text representing the contents of said contact center interaction;
extracting out of said interaction text a plurality of unstructured features based on a stored set of unstructured features previously identified as most closely related to customer satisfaction;
identifying out of a contact center database a plurality of structured features from among a stored set of structured features previously identified as most closely related to customer satisfaction;
generating a predicted customer satisfaction score from a combination of extracted unstructured and identified structured features; and
presenting the predicted customer satisfaction score.

2. The method of claim 1 wherein said generating a customer satisfaction score comprises steps of:
selecting at least one customer satisfaction model; and
applying the at least one customer satisfaction model to said combination of extracted unstructured and structured features to produce a customer satisfaction score.

3. The method of claim 2 wherein said selecting of at least one customer satisfaction model comprises identifying which of a plurality of customer satisfaction models best predicts observed customer satisfaction scores, said identifying comprising the steps of:
retrieving at least one stored customer satisfaction model;
selecting at least one stored customer interaction;
obtaining a plurality of data sets by computing for each customer interaction a set consisting of a plurality of unstructured and structured features, and a matching set containing at least one previously-obtained customer satisfaction score for each of said at least one stored customer interaction;
computing a plurality of predicted customer satisfaction scores for each of the at least one customer interactions based upon each said set consisting of a plurality of unstructured and structured features and each of said stored customer satisfaction models;
calculating a measure of degree of match between each of said plurality of predicted satisfaction scores and the previously-observed customer satisfaction score for the same customer interaction; and
identifying, from the plurality of said measures of degree of match, the model which produces the highest overall degree of match.

4. The method of claim 2 wherein said customer satisfaction model is obtained by the steps of:
selecting a plurality of customer interactions;
obtaining a plurality of structured and unstructured features by computing for each of said customer interactions;
retrieving for each of said features a customer satisfaction score for the corresponding customer interaction; and
applying any of a plurality of machine learning systems to a plurality of said features and said corresponding customer interactions to create a customer satisfaction model.

5. The method of claim 1 wherein said interaction text is selected from at least one of the following:
transcript of a call between the customer and at least one of a contact center agent and other contact center personnel;
transcript of a call between two contact center personnel;
text of an e-mail between the customer and contact center personnel; and
text of a computer chat between the customer and contact center personnel.

6. The method of claim 1 further comprising creating a plurality of partial interaction texts at repeated intervals during the interaction between the customer and the at least one contact center agent, with each of said partial interaction texts being used to create a separate customer satisfaction prediction score.

7. The method of claim 1 further comprising utilizing said real-time prediction of customer satisfaction to trigger a further action, said further action selected from a list of further actions including:
generating alerts to contact center supervisors that a customer may be dissatisfied;
causing display to the contact center agent of suggestions for improving satisfaction by the customer to whom the agent is speaking;
providing information to the agent of additional options for resolving the customer's issue; and
displaying specific suggestions to the agent for improving the customer's dissatisfaction based upon observed features in the interaction.

8. The method of claim 1 wherein said unstructured features may include features selected from a list of features extracted from the interaction, comprising at least one of the following:
prosodic features;
lexical features;
contextual features; and
acoustic features.

9. The method of claim 1 wherein said presenting the predicted customer satisfaction score comprises at least one of displaying the predicted customer satisfaction score to the customer service agent, displaying the predicted customer satisfaction score to a contact center representative other than the customer service agent, and delivering the predicted customer satisfaction score via electronic mail.

10. The method of claim 1, wherein said set of unstructured features previously identified as most closely related to customer satisfaction is identified by correlating features from stored previous interaction text with customer satisfaction survey results, by steps of:
acquiring stored interaction text of at least one previous interaction;
obtaining survey results of a customer satisfaction survey for the at least one previous interaction; and
identifying features in said interaction text that are related to customer satisfaction.

11. The method of claim 10 wherein said acquiring interaction text and said obtaining survey results comprise accessing a labeled interaction text that contains both the interaction text and at least one label containing the customer satisfaction survey results for that interaction.

12. The method of claim 10 wherein said identifying features in said interaction text that are related to customer satisfaction comprises steps of:
associating the interaction text with the survey results representing the customer satisfaction for the interaction captured in the interaction text;
extracting candidate interaction text features that are associated with said survey results;
computing a relationship score between each extracted interaction text feature and the associated survey results; and
generating a customer satisfaction model comprising a set of candidate features selected as those extracted interaction text features having highest relationship scores.

13. The method of claim 12 further comprising the steps of:
associating stored structured features from said interaction with said survey results representing the customer satisfaction for the same interaction as the structured data;
extracting one or more candidate structured features that are associated with survey results;
computing a relationship between each extracted candidate structured feature and the associated survey results; and
selecting extracted structured features having a strongest relationship for inclusion in said customer satisfaction model.

14. The method of claim 12 further comprising storing said identified features and a corresponding set of rules or statistics for the identified features, said set of rules or statistics selected by finding the rules or statistics that best separate one satisfaction class from other satisfaction class as a customer satisfaction model.

15. The method of claim 12 wherein said computing a relationship comprises steps of:
selecting at least one machine learning program; and
applying the at least one machine learning program to the extracted unstructured features and the associated survey results; and
outputting a relationship value from the machine learning program for each of said extracted unstructured features.

16. The method of claim 13 wherein said computing a relationship comprises steps of:
selecting at least one machine learning program; and
applying the at least one machine learning program to the extracted unstructured features, the extracted structured features and the associated survey results.

17. The method of claim 3 wherein said computing a plurality of predicted customer satisfaction scores for each of the at least one customer interactions based upon the paired data sets comprises invoking more than one machine learning component and further comprising a step of selecting learning results from one of said machine learning components for the customer satisfaction scores.

18. A system for automatically performing for real-time prediction of customer satisfaction for a contact center interaction between a customer and at least one customer service agent at the contact center comprising:
at least one interaction transcript component for obtaining a transcribed text of the interaction;
a customer satisfaction prediction component having at least one processing component for extracting out of said interaction text a plurality of unstructured features based on a stored set of unstructured features previously identified as most closely related to customer satisfaction, identifying out of a contact center database a plurality of structured features from among a stored set of structured features previously identified as most closely related to customer satisfaction, and generating a predicted customer satisfaction score from a combination of extracted unstructured and identified structured features; and
presentation means for presenting the predicted customer satisfaction score to at least one contact center personnel.

19. The system of claim 18 wherein the at least one customer satisfaction prediction component comprises a selector component for selecting at least one customer satisfaction model and applying the at least one customer satisfaction model to said combination of extracted structured and unstructured features.

20. The system of claim 18 further comprising a customer satisfaction model generation component for creating a customer satisfaction model by combining previous structured and previous unstructured features from previous interactions having associated customer satisfaction survey results and wherein the customer satisfaction model is used for generating the predicted customer satisfaction score from the combination of identified unstructured features and structured features.

21. The system of claim 18 wherein the at least one component for obtaining an interaction transcript comprises:
a capture component for capturing a conversation between a customer and a customer service agent; and
a speech transcription component for converting the captured conversation into transcribed text.

22. The system of claim 18 further comprising at least one database for storing at least one of call recordings, call transcripts, a customer satisfaction model and predetermined text and structured features correlated to customer satisfaction.

23. The system of claim 20 wherein the customer satisfaction model generating component further comprises:
a relationship analysis component for identifying features in said interaction text that are related to customer satisfaction by associating the interaction text with the survey results and with at least one stored structured features and extracting candidate interaction text features and stored structured features that are associated with survey results;
a customer satisfaction score component for computing a customer satisfaction score for each extracted interaction text feature and structured feature; and
a selection component for generating a customer satisfaction model comprising a set of candidate features selected as those extracted interaction text features and structured features having highest customer satisfaction scores.

24. The system of claim 23 further comprising at least one storage location for storing said identified features as a customer satisfaction model.

25. The system of claim 23 wherein said customer satisfaction score component computes a customer satisfaction score by selecting at least one machine learning program and invoking said at least one machine learning program to operate on the extracted interaction text features and further comprising a selection component for selecting learning results from one of said at least one machine learning components for the customer satisfaction scores.
